(19) United States
(12) Patent Application Publication
(10) Pub. No.: US 2007/0288202 A1
(43) Pub. Date: Dec. 13, 2007

(54) Method For Conducting Diagnostic Tests of Spray Equipment

(75) Inventor: Paul Sirgany, Ortonville, MI (US)

Correspondence Address: YOUNG & BASILE, P.C., 3001 WEST BIG BEAVER ROAD, SUITE 624, TROY, MI, 48084, US

(73) Assignee: DURR SYSTEMS, INC., Auburn Hills, MI (US)

(21) Appl. No.: 11/761,097

(22) Filed: Jun. 11, 2007

Related U.S. Application Data
(60) Provisional application No. 60/813,242, filed on Jun. 13, 2006.

(51) Int. Cl. G06F 19/00; G06F 17/40

(52) U.S. Cl. 702/182; 702/1; 702/33; 702/34; 702/127; 702/187; 702/189

(57) ABSTRACT

A method for conducting diagnostic tests of spray equipment in a hazardous environment. The method includes automatically gathering test data, comparing the automatically gathered test data to a database of baseline data, and providing a signal if the automatically gathered data differs from the baseline data by a predetermined amount.

### CROSS-REFERENCE TO RELATED APPLICATIONS

This application claims the benefit of U.S. Provisional Application No. 60/813,242, filed Jun. 13, 2006, which is incorporated by reference herein in its entirety.

### FIELD OF THE INVENTION

The present invention relates to a method for conducting diagnostic tests of spray equipment, and more particularly, the present invention relates to a method for validating performance of automated paint process equipment while reducing the need for maintenance personnel to enter hazardous areas during the diagnostic process.

### BACKGROUND

The process used to paint many industrial items and/or automobiles is highly automated. Frequently, spray equipment is mounted to a robot where the robot guides the spray equipment over a workpiece. While the workpiece may be painted by a single robot, it is not uncommon for several robots to be integrated into a painting station, where the robots cooperate to paint the workpiece. The spray equipment may be of a wide variety of types ranging from a comparatively simple spray gun to more complicated systems that include electrostatic charge devices, rotating bells, air bearings and color changers. Regardless of the level of complexity of the spray apparatus, diagnostics are run to ensure that the paint systems function properly. However, painting stations are hazardous areas due to the highly automated nature of the equipment and the potential for operator injury if the robots moved unexpectedly.

In the prior art, the operator repeatedly entered the hazardous area of the painting stations to perform diagnostic procedures. In practice the operator would conduct one or more diagnostic tests on a daily basis, and doing so would require the operator to enter the hazardous area of the painting station at least once, and possibly several times. For example, the operator may be required to validate the operation of high voltage electrostatic paint material charging systems, to validate the rotation velocity of rotary atomizers, to validate color change performance, to validate spray patterns, to validate paint delivery system flow rates, or to validate cleaning agent flow rates.

Each of these tests required the operator to enter the hazardous area of the painting station while carrying specialized test equipment and many of these tests required the operator to enter the hazardous area of the painting station multiple times during the test. In order to enter the hazardous area of the painting station, the operator must execute a time consuming safety lockout procedure, which ensures the safety of the operator by cutting power to the equipment in the painting station using known methods. However, some tests require that the operator restore power to certain equipment by disabling some of the safety interlocks, and thus, injury due to unexpected movement of robotic equipment remains possible.

It would be desirable to have a method for conducting diagnostic tests of spray equipment wherein entry of the operator into the hazardous area of the painting station is minimized.

### SUMMARY

The present invention provides a method for conducting diagnostic tests of spray equipment. In one method taught herein, diagnostic tests may be performed on spray equipment which is located in a hazardous environment by automatically gathering test data, comparing the automatically gathered test data to a database of baseline data, and providing a signal if the automatically gathered data differs from the baseline data by a predetermined amount. The database of baseline data may be provided by storing empirically verified test data in the database of baseline data. More specifically, providing the database of baseline data may include measuring test values corresponding to a performance characteristic of the spray equipment empirically while contemporaneously monitoring digital feedback from the spray equipment, correlating the empirically measured test values to the contemporaneous digital feedback to provide baseline data, and storing the baseline data in the database of baseline data. While not necessarily so limited, the performance characteristic may be rotational velocity or electrostatic performance of the spray equipment. A human machine interface is outside the hazardous area and test data is automatically gathered by transmitting digital feedback to the human machine interface, wherein comparing the automatically gathered data to the database of baseline data and providing a signal if the automatically gathered data differs from the baseline data by a predetermined amount is performed by the human machine interface.

In another method taught herein, a maintenance hatch is provided in a wall bounding the hazardous environment. To conduct a diagnostic test, the spray equipment is automatically moved to a position adjacent the maintenance hatch, the maintenance hatch is opened and test equipment is placed therein adjacent the spray equipment. The maintenance hatch is then closed and the maintenance test is performed. Then, the test equipment is retrieved through the maintenance hatch; and the results of the test are measured. Furthermore, the results of the test may be entered into a human machine interface located outside the hazardous environment, wherein the results of the test are compared to a database of baseline data using the human machine interface and a signal is provided using the human machine interface if it is determined that the results of the automatically gathered data differs from the baseline data by a predetermined amount.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is an illustration showing a painting station according to the method of the present invention.

### DETAILED DESCRIPTION

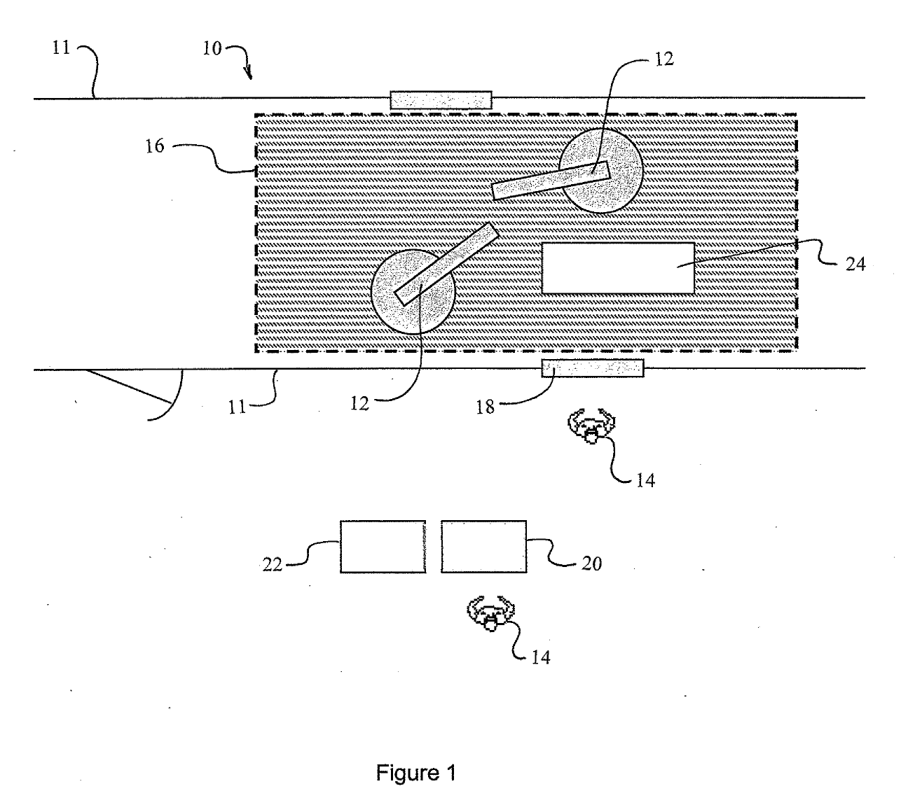

The present invention provides a method for conducting diagnostic tests of spray equipment 12 located within a painting station 10, as shown in FIG. 1. The painting station 10 is a substantially enclosed environment, bounded by one or more walls 11. The spray equipment 12 includes one or more robotic painting systems operable to paint workpieces (not shown) in an automated process. Due to the possibility that unexpected movement of the spray equipment 12 could injure an operator 14 of the spray equipment 12 when the spray equipment 12 is enabled, a hazardous area 16 is defined within the painting station 10. When necessary, an operator 14 may place test equipment or test media, such as a beaker for measuring paint output or a test strip for verifying color change, into the hazardous area 16 through a maintenance hatch 18. The maintenance hatch 18 is a small access port through the wall 11 of the painting station 10 that allows the operator 14 to place small items into the hazardous area 16 of the painting station 10 and later retrieve those items without entering the painting station 10. However, the operator 14 may enter the painting station 10 as necessary, after deactivating the spray equipment 12 using a lock-out mechanism 20. For example, paint spray patterns may typically be validated by conducting a paint spray pattern test on a small test sheet that is inserted into the painting station 10 through the maintenance hatch 18. However, from time to time it may be necessary, in order to validate of paint spray patterns, for the operator 14 to physically enter the hazardous area 16 of the painting station 10 to place and later retrieve a large sheet of test media 24 for the purpose of validating paint spray patterns.

In order to allow control of the spray equipment 12 from outside the painting station 10, a human machine interface 22 is provided outside of the painting station 10 and operatively connected to the spray equipment 12 to allow the operator 14 to control the spray equipment 12 and receive digital feedback data from sensors provided on the spray equipment 12 and associated test equipment. The digital feedback data provided by the sensors on the spray equipment 12 may include, but is not limited to, voltages of electrostatic spray equipment, rotational velocities of bell cups, and flow rates of paint and cleaning agents. Furthermore, the digital feedback data may be provided based on either direct or indirect measurements.

In order to provide a data set for comparison purposes, data is gathered empirically regarding the performance characteristics of interest by directly measuring the performance of the spray equipment 12 using known empirical methods. This is typically performed during commissioning of the spray equipment 12 or during later maintenance or recalibration, and the results of these measurements may be validated by comparing the empirically gathered data to performance specifications provided by the manufacturer of the spray equipment 12. While the empirical data is gathered, the digital feedback from the spray equipment 12 is recorded and correlated with the empirical measurements to create a baseline data set.

During the automated diagnostic tests, digital feedback data is gathered remotely by the operator 14 using the human machine interface 22, and the digital feedback data is compared to the baseline data set. If the values of the current test data and the baseline data set are within a predefined window the test is considered passed and the results are stored for further review. If the difference is outside the predefined window the test fails. This comparison is performed automatically by the human machine interface 22, eliminating the need to resort to written standards. The result of the comparison is a “pass or fail” indication that is presented to the operator 14 and simultaneously recorded by human machine interface 22. A graph may be displayed overlaying both sets of results and highlighting the deviation in a failed test, and this graph may also be stored for further review. Optionally, the spray equipment 12 may be disabled until the failure is corrected. Thus, entry of the operator 14 into the hazardous area 16 is minimized by empirically gathering valid test data to establish a baseline data set, utilizing a human machine interface 22 located outside of the hazardous area 16 to automatically gather test data, comparing the automatically gathered test data with the empirically gathered data in the previously acquired baseline data set, and providing a signal if the automatically gathered data differs from the empirically gathered data by a predetermined amount.

In many cases, by comparing the digitally gathered feedback data to benchmark data gathered using empirical methods, the operator 14 is not required to enter the hazardous area 16 at all. For example, the electrostatic performance and the rotational performance of the spray equipment 12 may be verified without entry into the hazardous area 16.

Alternatively, the human machine interface may be employed to conduct diagnostic tests wherein, test equipment or test media is introduced into the hazardous area 16 of the painting station 10 through the maintenance hatch 18. By way of example, this may be useful to validate paint delivery system performance and cleaning agent delivery system performance by way of a flow test, or to otherwise gather a volumetric sample. After the operator 14 instructs the human machine interface 22 to start the desired test, the spray equipment 12 automatically moves into position adjacent to the maintenance hatch 18. Once the spray equipment 12 has reached the desired position, the human machine interface 22 prompts the operator 14 to begin the lockout procedure. The user then operates the lockout device 20 to deactivate the spray equipment 22. After the human machine interface 22 confirms that the spray equipment 12 has been deactivated using the lockout device 20, the human machine interface 22 prompts the operator 14 to open the maintenance hatch 18. The operator 14 then opens the maintenance hatch and places the test equipment or the test media, as required, into the hazardous area 16 of the painting station 10 through the maintenance hatch 18. In the case of a flow test, a beaker or other measurement vessel may be placed into the hazardous area 16 of the painting station 10 through the maintenance hatch 18. After the test equipment or media is in place, the operator 14 may close the maintenance hatch 18 and operate the lockout device 20 to reactivate the spray equipment 12. The operator 14 then uses the human machine interface 22 to execute the desired test. Once the test is completed, the test equipment or test media may be retrieved from the painting station 10 through the maintenance hatch 18. If necessary, the operator 14 can be prompted by the human machine interface 22 to enter the results of the test, which may be stored in a database. The test may be repeated using other parameters as necessary. At the conclusion of the testing, the test results are compared to the baseline data set for comparison and analysis as previously described.

By another alternative, diagnostic tests may be performed using empirical methods in a manner that precludes having the operator 14 make multiple entries into the hazardous area 16, and which eliminates the need for the operator to be present in the hazardous area 16 while the spray equipment 12 is activated. By way of example, color change performance and paint spray patterns may be validated in this manner.

In order to initialize the test, the operator 14 instructs the human machine interface 22 to start the test. Upon starting the test, the spray equipment 12 moves to a safe position. Once the spray equipment 12 is in a safe position, the human machine interface 22 prompts the operator 14 to use the lockout device 20 to deactivate the spray equipment. The human machine interface 22 monitors the lockout device 20 for compliance, and prompts the operator 14 when the spray equipment 12 is deactivated and it is thus safe to enter the hazardous area 16. To prepare the spray equipment 12 for the diagnostic test, the operator 14 enters the hazardous area 16 and places the test media 24 in the hazardous area 16 within the painting station 10. After exiting the hazardous area 16, the operator 14 activates the spray equipment 12 using the lockout device 20, and the human machine interface 22 may proceed with the test. After the spray equipment 12 completes the test, the operator 14 retrieves the test media 24 from the hazardous area 16, operating the lockout device 20 as necessary. The human machine interface 22 then prompts the operator 14 to enter the results of the test, which may be stored in a database by the human machine interface 22.

While the invention has been described in connection with what is presently considered to be the most practical and preferred embodiment, it is to be understood that the invention is not to be limited to the disclosed embodiments, but to the contrary, it is intended to cover various modifications or equivalent arrangements included within the spirit and scope of the appended claims. The scope is to be accorded the broadest interpretation so as to encompass all such modifications and equivalent structures as is permitted under the law.

What is claimed is:

1. A method for conducting diagnostic tests of spray equipment in a hazardous environment comprising:
automatically gathering test data;
comparing the automatically gathered test data to a database of baseline data; and
providing a signal if the automatically gathered data differs from the baseline data by a predetermined amount.

2. The method of claim 1 further comprising:
providing the database of baseline data by storing empirically verified test data in the database of baseline data.

3. The method of claim 1 further comprising:
measuring test values corresponding to a performance characteristic of the spray equipment empirically while contemporaneously monitoring digital feedback from the spray equipment;
correlating the empirically measured test values to the contemporaneous digital feedback to provide baseline data; and
storing the baseline data in the database of baseline data.

4. The method of claim 3, wherein the performance characteristic is rotational velocity.

5. The method of claim 3, wherein the performance characteristic is electrostatic performance of the spray equipment.

6. The method of claim 1 further comprising:
providing a human machine interface outside the hazardous area and automatically gathering test data by transmitting digital feedback to the human machine interface, wherein comparing the automatically gathered data to the database of baseline data and providing a signal if the automatically gathered data differs from the baseline data by a predetermined amount is performed by the human machine interface.

7. A method for conducting diagnostic tests of spray equipment in a hazardous environment comprising;
measuring test values corresponding to a performance characteristic of the spray equipment empirically while contemporaneously monitoring digital feedback from the spray equipment;
correlating the empirically measured test values to the contemporaneous digital feedback to provide baseline data;
storing the baseline data in a database of baseline data;
automatically gathering test data;
comparing the automatically gathered test data to the database of baseline data; and
providing a signal if the automatically gathered data differs from the baseline data by a predetermined amount.

8. The method of claim 7 further comprising:
providing a human machine interface outside the hazardous area and automatically gathering test data by transmitting digital feedback to the human machine interface, wherein comparing the automatically gathered data to the database of baseline data and providing a signal if the automatically gathered data differs from the baseline data by a predetermined amount is performed by the human machine interface.

9. The method of claim 7, wherein the performance characteristic is rotational velocity.

10. The method of claim 7, wherein the performance characteristic is electrostatic performance of the spray equipment.

11. A method for conducting diagnostic tests of spray equipment in a hazardous environment comprising:
providing a maintenance hatch in a wall bounding the hazardous environment;
moving the spray equipment to a position adjacent the maintenance hatch automatically;
opening the maintenance hatch and placing test equipment adjacent the spray equipment;
closing the maintenance hatch;
performing a maintenance test;
retrieving the test equipment through the maintenance hatch; and
measuring the results of the test.

12. The method of claim 11 further comprising:
entering the results of the test into a human machine interface located outside the hazardous environment;
comparing the results of the test to a database of baseline data using the human machine interface; and
providing a signal using the human machine interface if the results of the automatically gathered data differs from the baseline data by a predetermined amount.

13. An apparatus for conducting diagnostic tests of spray equipment in a hazardous environment comprising:
at least one sensor for automatically gathering test data;
at least one processor for comparing the automatically gathered test data to a database of baseline data; and
at least one program running on the at least one processor for providing a signal if the automatically gathered data differs from the baseline data by a predetermined amount.

14. The apparatus of claim 13 further comprising:
at least one data storage medium for providing the database of baseline data by storing empirically verified test data in the database of baseline data.

15. The apparatus of claim 13 further comprising:
at least one test sensor for measuring test values corresponding to a performance characteristic of the spray equipment empirically while contemporaneously monitoring digital feedback from the spray equipment;
at least one correlation processor for correlating the empirically measured test values to the contemporaneous digital feedback to provide baseline data; and
at least a portion of the storage medium available for storing the baseline data in the database of baseline data.

16. The apparatus of claim 15, wherein the performance characteristic is rotational velocity.

17. The apparatus of claim 15, wherein the performance characteristic is electrostatic performance of the spray equipment.

18. The apparatus of claim 13 further comprising:
a human machine interface provided outside the hazardous area and automatically gathering test data by transmitting digital feedback to the human machine interface, wherein comparing the automatically gathered data to the database of baseline data and providing a signal if the automatically gathered data differs from the baseline data by a predetermined amount is performed by the human machine interface.

19. An apparatus for conducting diagnostic tests of spray equipment in a hazardous environment comprising;
a maintenance hatch located in a wall bounding a hazardous environment;
spray equipment located within the hazardous environment and automatically movable to a position adjacent the maintenance hatch;
test equipment to be placed adjacent the spray equipment for a testing procedure, capable of being transferred through the maintenance hatch when opened; and
a maintenance test to be performed after the maintenance hatch is closed.

20. The apparatus of claim 19 further comprising:
a human machine interface located outside the hazardous environment for entering results of the test procedure;
a database of baseline data for comparing the results of the test procedure using the human machine interface; and
a signal provided using the human machine interface, if the results of the automatically gathered data differs from the baseline data by a predetermined amount.
